(19) United States
(12) Patent Application Publication
(10) Pub. No.: US 2008/0190920 A1
(43) Pub. Date: Aug. 14, 2008

(54) Container

(76) Inventors: Peter Antony Farrar, Leeds (GB); Robert Johnston, Northants (GB); Anthony Henry Joseph Fraser, Rutland (GB); Ralph Scott Peterson, Clifton Forge, VA (US)

Correspondence Address: MEADWESTVACO CORPORATION;Attn: Ivette Reyes, 299 PARK AVENUE, 13TH FLOOR, NEW YORK, NY, 10171, US

(21) Appl. No.: 11/574,265

(22) PCT Filed: Aug. 26, 2005
(86) PCT No.: PCT/GB05/03331

§ 371 Date: Nov. 9, 2007

Related U.S. Application Data
(60) Provisional application No. 60/605,005, filed on Aug. 27, 2004.

(51) Int. Cl. B65D 55/02; B65D 6/02; E05B 65/00

(52) U.S. Cl. 220/4.22; 206/1.5; 70/77

(57) ABSTRACT

A container having lid and base portions (1,2) which are moveable between open and closed positions and a locking mechanism comprising: a holding bar (3) within the container moveable between a release position and a holding position in which it prevents the container being opened and a security device (4) which is insertable in the container so as to move the holding member (3) into the holding position and which is secured in this position by a locking device until released by application of a key or release apparatus.

### TECHNICAL FIELD

This invention relates to a container and, more particularly, a container for securely housing goods for display in a retail outlet. Such containers are referred to in the trade as “safers”. The invention also relates to a container adapted to receive a security device and to a security device for use therein.

### BACKGROUND ART

Containers used as safers are used to house goods such as compact disks (CDs) and digital versatile disks (DVDs), these being housed in conventional CD or DVD boxes, such as those described in U.S. Pat. No. 5,788,068 and U.S. Pat. No. 6,502,694. Such containers typically comprise a tough plastic box, e.g. formed of polycarbonate, with a base portion and lid portion which are pivotably connected at one edge and secured together by a locking mechanism at the opposite edge. A variety of locking mechanism are in use.

This invention aims to provide a container which can be securely locked in the closed position yet is easy to release upon application of a key or appropriate release apparatus.

### SUMMARY OF INVENTION

According to a first aspect of the invention, there is provided a container comprising: first and second parts which are moveable between open and closed positions and a locking mechanism comprising: a holding member within the container moveable between a release position in which it does not prevent the first and second parts moving to the open position and a holding position in which it prevents the first and second parts moving to the open position; and a securing device which is insertable in the container so as to move the holding member into the holding position and which carries a locking device to secure it in this position until released by application of a key or other predetermined release apparatus.

According to a second aspect of the invention, there is provided a container comprising: first and second parts which are moveable between open and closed positions, the first and second parts each having at least one elongate side which lie adjacent each other in said closed position, and a locking mechanism for securing the first and second parts in the closed position comprising a holding member which extends along a substantial part of said elongate side of each of the first and second parts so as to prevent the first and second parts moving to the open position.

According to a third aspect of the invention there is provided a security device for use in the above mentioned containers.

According to another aspect of the invention there is provided a security device insertable into a container to secure the container in a closed configuration and/or to secure an article to the container, the security device including: a locking member moveable by magnetic forces between a locked position in which it prevents release of the security device and a release position in which it allows the security device to be released, and a magnet for applying a first magnetic force in a first direction to the locking member so as to hold it in the locked position, whereby the security member can be released by application of a second magnetic force greater than said first magnetic force and in the opposite direction to the first direction so as to counteract the first magnetic force and move the locking member to the release position.

According to a further aspect of the invention, there is provided a container adapted to receive such security devices.

Preferred and optional features of the invention will be apparent from the following description and from the subsidiary claims of the specification.

### BRIEF DESCRIPTION OF THE DRAWINGS

The invention will now be further described, merely by way of example, with reference to the accompanying drawings, in which:

FIG. 1 is a perspective view of a first embodiment of a container according to the invention;

FIG. 2A is a cross-section along line A-A of FIG. 1 and FIG. 2B is a perspective view broken away along line B-B of FIG. 1, these Figures showing the parts of the container when in an unlocked position;

FIG. 3A is a cross-section along line A-A of FIG. 1 and FIG. 3B is a perspective view broken away along line B-B of FIG. 1, these Figures showing the parts of the container when in a locked position;

FIG. 4A is a cross-section along line C-C of FIG. 1 when the container is locked in a closed position, FIG. 4B is a cross-section along line C-C of FIG. 1 in an intermediate position whilst the container is being unlocked, and FIG. 4C is a cross-section along line C-C of FIG. 1 when the container has been unlocked and opened.

### DESCRIPTION OF PREFERRED EMBODIMENTS

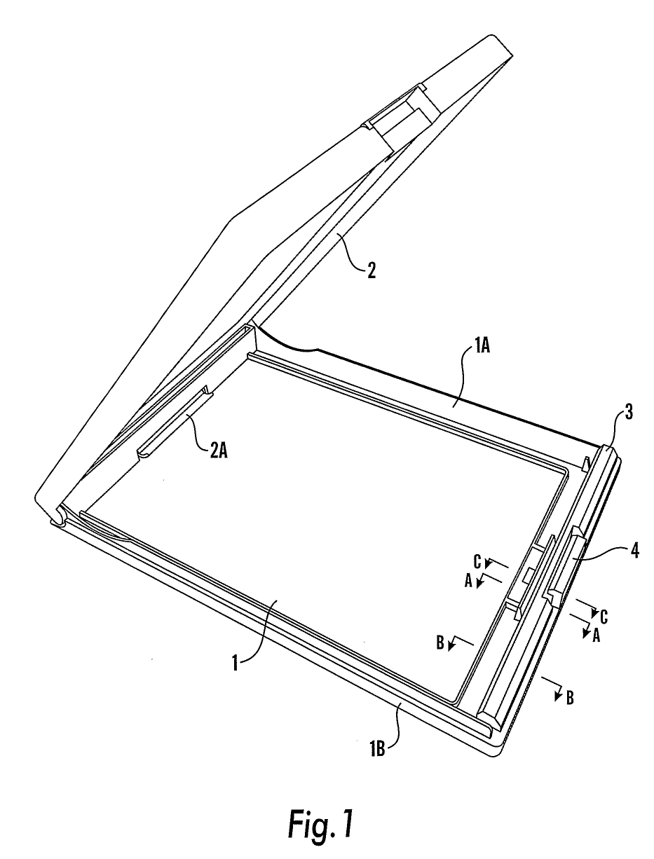

FIG. 1 shows a container comprising a rectangular base portion 1 and a rectangular lid portion 2 pivotably connected to each other along one edge by a hinge. At the opposite edge of the container, a holding bar 3 moveable between a release position and a holding position is provided and a security device 4 for securing the bar 3 in the holding position.

The holding bar 3 extends along substantially the entire length of an opening edge of the base portion 1 and is pivotably mounted thereto by pins (not shown) at each end thereof which fit into sockets (not shown) in sides 1A and 1B of the base portion 1 so as to be pivotable about an axis parallel to its length.

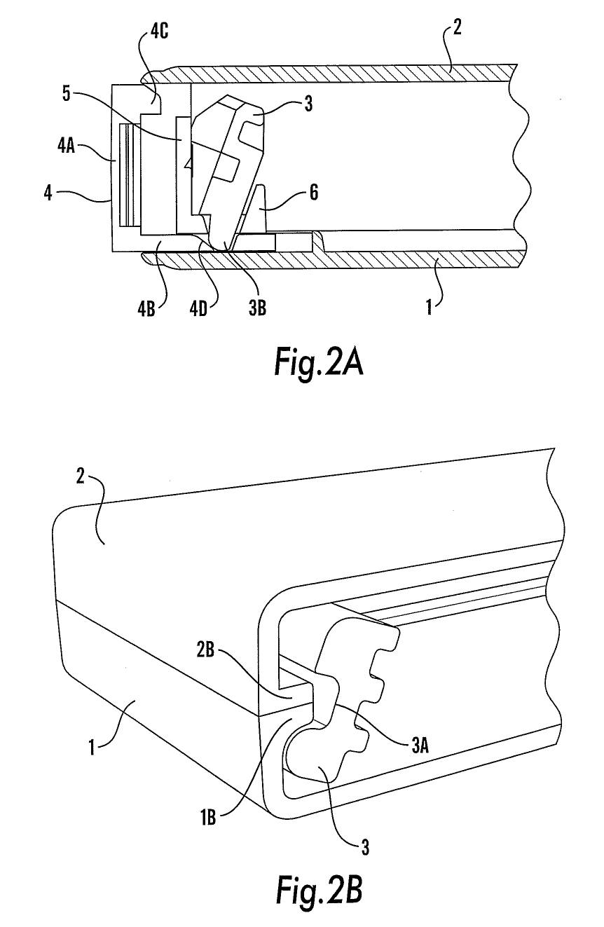

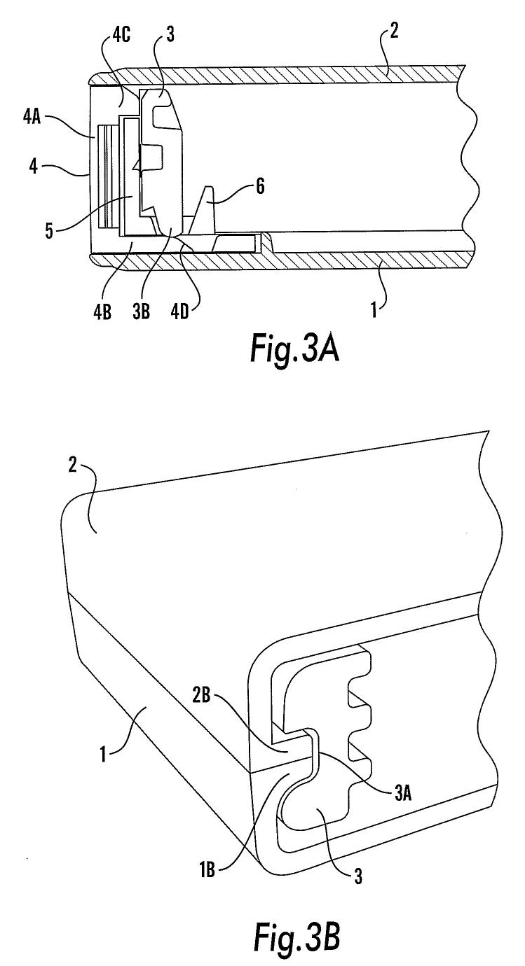

FIGS. 2, 3 and 4 shows cross-sections of the bar 3 at various positions along its length. FIGS. 2B and 3B illustrate how the bar pivots from a release position (shown in FIG. 2B) to a holding position (shown in FIG. 3B) in which internal ribs 1B and 2B of the lid and base portion, which extend along most of the length of one side of the container, fit within a groove 3A in the bar 3 so the lid and base portions 1, 2 are held in the closed position. The bar 3 thus interlocks with the lid and base portions 1, 2 along one side thereof to securely hold them in the closed position.

As shown in FIGS. 2A and 3A, the bar 3 is also located between upstands 5 and 6 which project up from the base portion 1.

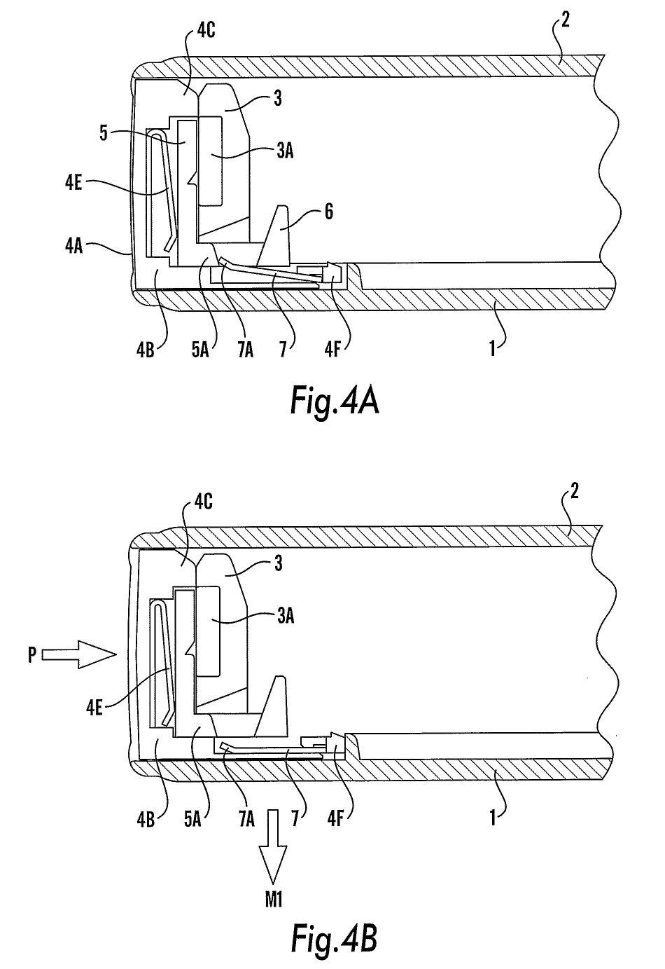

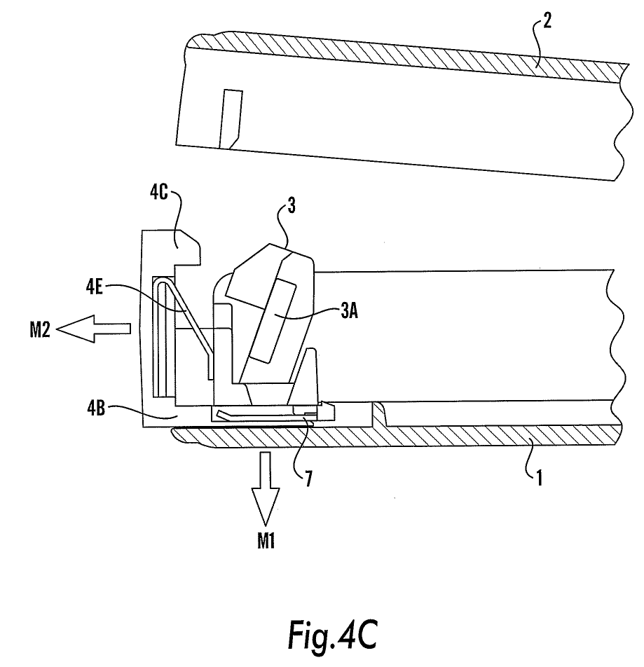

The security device 4 comprises a substantially flat body member 4A which, in use, lies adjacent the exterior of the container, e.g. within a recess in the opening edge thereof formed by recesses in the base and lid portions 1, 2 (as shown in FIGS. 3A and 4A). A first arm 4B projects from a lower edge of the body member 4A and a second arm 4C projects from an upper edge of the body member 4A. The first arm 4B is slidable within a slot in the base portion 1 to enable the security member to be slid from a withdrawn position (shown in FIG. 2A) in which the body member 4A projects from the edge of the container to an inserted position (shown in FIG. 3A) in which the body member 4A fits within said recess so the outward facing surface of the body member 4A lies flush with the exterior of the container.

The first arm 4B fits within a gap or slot between the holding member and the interior of the container and is provided with a ramp surface 4D which engages a lower edge 3B of the bar 3 as the security member 4 is inserted into the container to pivot the bar 3 from its release position (shown in FIGS. 2A and 2B) to its holding position (shown in FIGS. 3A and 3B).

The second arm 4C engages with the lid portion 2 so that the security device also serves to hold the lid and base portions in the closed position as well as the holding bar 3 (in a similar manner to the security device described in WO02/39451).

The security device 4 carries a metal locking arm 7 on the first arm 4A which allows the arm 4A to be inserted but which moves from a retracted position to a projecting position (see FIG. 4A) when the arm 4A has been inserted to the position shown. The locking arm 7 may, for instance, be resiliently biased towards the projecting position so it moves up to engage a detent 5A on the underside of upstand 5. The security device 4 cannot then be withdrawn from the container. The locking arm 7 thus provides a snap-fit between the security device 4 and the container.

To open the container, it is necessary to release the security device 4. This is done by applying a first magnetic force M1 in a downwards direction to pull the locking arm 7 down from the projecting position to the retracted position shown in FIG. 4B. In the arrangement shown, in order to allow the locking arm 7 to be pulled down to the retracted position, it is necessary to push the security device 4 slightly further into the container (as indicated by arrow P) so the end 7A of the locking arm disengages from the detent 5A. Once the locking arm has been pulled down to the retracted position (as shown in FIG. 4B), the security device can be withdrawn to disengage the ramp 4D from the holding arm 3 so the holding arm can pivot out of engagement with the ribs 1B, 2B so allowing the lid portion 2 to be opened (as shown in FIG. 4C).

Instead of locking arm 7 being resiliently urged towards the projecting position, it may be urged upwards by a magnetic force M3 (not shown). This may be provided by a first magnet 3A carried by the holding bar 3. Thus, the magnetic force M1 applied to release the security device must be sufficient to counteract magnetic force M3 and pull the arm 7 down to the retracted position.

A resilient metal spring 4E is also provided between the body member 4A of the security device and the upstand 5 to urge the security device 4 to the locked position shown in FIG. 4A and thus hold the locking arm 7 in engagement with detent 5A. To release the security device 4, it is pushed inwards slightly (as described above) against the action of spring 4E to the position shown in FIG. 4B. Once the locking arm 7 has disengaged from the detent 5A, the spring 4E urges the security member 4 outwards to assist in its withdrawal to the position shown in FIG. 4C. The magnetic release apparatus (not shown) used to apply the first magnetic force M1 may also provide a second magnetic force M2 to assist in withdrawing the security device 4 to the position shown in FIG. 4C. This second magnet preferably projects from the release apparatus so it can be used to push the security member into the container against the action of spring 4E (from the position shown in FIG. 4A to that shown in FIG. 4B).

The magnetic attraction between magnet 3A in the holding arm 3 and the metal spring 4E also assists in holding the arm 3 in the holding position shown in FIG. 4A. The magnet 3A is, however, orientated so as to be repelled by the magnet in the release apparatus used to provide the second magnetic force M2 so as to move the holding arm 3 to the release position shown in FIG. 4C once the security device 4 has been withdrawn.

To avoid the holding bar 3 inadvertently returning to the holding position whilst the container is open and the security device 4 is in the withdrawn position, it is preferably releasably held in the release position, e.g. by small projections (not shown) provided on side walls 1A, 1B until it is forced into the holding position again upon re-insertion of the security device 4. [I'm assuming this is a desirable modification having played with the prototype].

The security device may be removable from the container but is preferably held captive therewith so the container is ready for re-use in a retail outlet once the goods secured therein have been sold. In the embodiment shown, an upstand 4F on the inner end of arm 4B engages the upstand 6 of the base portion 1 to prevent the security member being withdrawn beyond the position shown in FIG. 4C.

A container adapted to receive such a security device and/or such a holding bar may be provided and the security device and/or holding bar subsequently installed therein.

As mentioned above, the security device is preferably arranged so as to be releasable upon application of release apparatus which provides a first magnetic force to move the locking arm to the retracted position and a second magnetic force (typically perpendicular to the first magnetic force) to assist in withdrawing the security device from the container. Suitable release apparatus is described in WO02/39451 and in GB0324341.7 which is also designed to release security devices in CD and DVD boxes. The retail outlet can thus use the same release apparatus for releasing security devices in a variety of different products an packaging.

The container is preferably formed of a tough, transparent plastic material, e.g. polycarbonate, similar to the materials used for conventional safers. The hinge between the lid and base portions 1, 2 is preferably of a type in which the lid and base portion are interlocked along the length of the hinge. The lid and base portions 1, 2 are thus interlocked along opposite edges so providing a very robust container which is very difficult to prize open without releasing the security device.

The lid portion is provided with an ejection arm 2A which services to lift the goods held within the container as the lid is moved to the open position to facilitate removal of the goods from the container.

As described above, the locking arm 7 may be biased towards its projecting position by a magnetic force, e.g. by attraction by a magnet provided in the container. This idea is also applicable to other types of security devices (such as those described in WO02/39451) independently of the use of a holding bar 4 such as that described above.

Whilst the container has been described in relation to housing a CD or DVD box, it will be appreciated that a wide variety of other goods may be housed therein, the container either being the primary container for the goods or a secondary container, i.e. a safer for deterring theft of a primary container housed therein. As is well known in the field, the container may be provided with a security tag which triggers an alarm if removed from the retail outlet.

1. A container comprising: first and second parts which are moveable between open and closed positions and a locking mechanism comprising: a holding member within the container moveable between a release position in which it does not prevent the first and second parts moving to the open position and a holding position in which it prevents the first and second parts moving to the open position; and a security device which is insertable in the container so as to move the holding member into the holding position and which carries a locking device to secure it in this position until released by application of a key or other predetermined release apparatus.

2. A container as claimed in claim 1 in which the holding member is pivotably mounted to the first part of the container.

3. A container as claimed in claim 1 or 2 in which the holding member interlocks with the first and second parts along a side thereof.

4. A container as claimed in claim 3 in which the holding member interlocks with the first and second parts along substantially the entire length of said side.

5. A container as claimed in any preceding claim in which the first and second parts each comprises an internal projection which interlocks with a groove or recess in the holding member in the holding position.

6. A container as claimed in any preceding claim in which the holding member is moveable between its holding position and its release position by application of a magnetic force.

7. A container as claimed in claim 6 in which the holding member includes a first magnet.

8. A container as claimed in claim 7 in which the holding member is urged towards said holding position by attraction between said first magnet and a magnetic components provided in the container and/or in the securing device.

9. A container as claimed in any preceding claim in which the security member is receivable in a gap or slot between the holding member and the interior of the container.

10. A container as claimed in any preceding claim in which the security device comprises a first arm which is slidable into the first part of the container.

11. A container as claimed in claim 10 in which the security device comprises a second arm which is engageable with the second part of the container when in the closed position.

12. A container as claimed in any preceding claim in which the security device comprises a body member which, in the locked position, lies adjacent the exterior of the container.

13. A container as claimed in claim 12 in which the body member fits within a recess in the exterior of the container.

14. A container as claimed in any preceding claim in which the locking device is actuated as the security device is inserted into the container to move the holding member to the holding position.

15. A container as claimed in claim 14 in which the locking device snap-fits with the container as the security device is inserted therein.

16. A container as claimed in claim 15 in which the locking device comprises a locking arm which is moveable between a first, retracted position in which it does not prevent insertion or withdrawal of the security device and a second, projecting position in which it prevents withdrawal of the security device.

17. A container as claimed in claim 16 in which the locking arm is moveable by application of a magnetic force thereof.

18. A container as claimed in claim 17 when dependent upon claim 8 in which the locking arm is urged towards the projecting position by said first magnet.

19. A container as claimed in any preceding claim in which the security device comprises a ramp-shaped member which engages with the holding member so the holding member is forced into the holding position as the security device is inserted into the container.

20. A container as claimed in any preceding claim in which the security device is held captive therewith.

21. A container as claimed in claims 10 and 11, or any claims dependent thereon, in which the first and second arms respectively engage the first and second parts of the container so as to hold them in the closed position.

22. A container as claimed in any preceding claim in which the locking device can only be released when the security device is moved further into the container from its locked position.

23. A container as claimed in claim 22 in which movement of said security device further into the container is against the action of a resilient member acting between the security device and the container.

24. A container as claimed in any preceding claim in which the security device is arranged to be released by release apparatus which provides two magnetic forces, a first magnetic force which moves the locking device from a projecting position to a retracted position and a second magnetic force which assists in withdrawing the security device from the container.

25. A container as claimed in claim 24 when dependent upon claim 7 in which the holding member is arranged to be moved by said first magnetic force from the holding position to the release position once the security device has been withdrawn a sufficient distance to permit this movement.

26. A container as claimed in any preceding claim in which the first and second parts form a robust, substantially transparent container for housing goods for display in a retail outlet.

27. A container as claimed in claim 26 comprising an ejection member which acts to raise the goods to facilitate their removal as the first and second parts are moved to the open position.

28. A container as claimed in any preceding claim in which the first part comprises a base portion and the second part comprises a lid portion, the base and lid portion being hinged to each other.

29. A container as claimed in claim 28 in which the base portion and lid portion are hinged to each other along a first edge of the container and the holding member is arranged to hold the base portion and lid portion together along a second edge of the container opposite the first edge.

30. A container as claimed in claim 29 in which the base and lid portions, when in the closed position and locked by the security device are interlocked with each other along both said first and second edges.

31. A container comprising: first and second parts which are moveable between open and closed positions, the first and second parts each having at least one elongate side which lie adjacent each other in said closed position, and a locking mechanism for securing the first and second parts in the closed position comprising a holding member which extends along a substantial part of said elongate side of each of the first and second parts so as to prevent the first and second parts moving to the open position.

32. A security device insertable into a container to secure the container in a closed configuration and/or to secure an article to the container, the security device including a locking member moveable by magnetic forces between a locked position in which it prevents release of the security device and a release position in which it allows the security device to be released, and a magnet for applying a first magnetic force in a first direction to the locking member so as to hold it in the locked position, whereby the security member can be released by application of a second magnetic force greater than said first magnetic force and in the opposite direction to the first direction so as to counteract the first magnetic force and move the locking member to the release position.

33. A security device for use in a container as claimed in any of claims 1-31.

34. A container comprising first and second parts adapted to receive a security device as claim in claim 32 or 33.
